(19) United States
(12) Patent Application Publication
(10) Pub. No.: US 2020/0410588 A1
(43) Pub. Date: Dec. 31, 2020

(54) DETERMINING VALUE OF SOURCE OF DATA

(71) Applicant: Oath Inc., New York, NY (US)

(72) Inventor: Eric Theodore Bax, Sierra Madre, CA (US)

(21) Appl. No.: 16/451,223

(22) Filed: Jun. 25, 2019

(51) Int. Cl. G06Q 40/04; G06Q 40/08; G06Q 20/10

(52) U.S. Cl. CPC G06Q 40/04; G06Q 20/108; G06Q 40/08

(57) ABSTRACT

One or more computing devices, systems, and/or methods are provided. One or more actions may be performed based upon a plurality of sets of data. A first value associated with performance of the one or more actions may be determined. A plurality of sources of the plurality of sets of data may be determined based upon the plurality of sets of data. A plurality of values associated with the plurality of sources may be determined based upon the first value and/or the plurality of sets of data. A plurality of payment values associated with the plurality of sources may be generated based upon the plurality of values. A first payment value of the plurality of payment values may be associated with a first source of the plurality of sources. A first payment associated with the first payment value may be transferred to a first account associated with the first source.

### BACKGROUND

Many systems use data about individuals to perform various functions, such as provide services and/or resources, select content for presentation to users and/or trade shares in an equity market. Performance of actions based upon the data may lead to profits and/or losses for an organization.

### SUMMARY

In accordance with the present disclosure, one or more computing devices and/or methods are provided. In an example, one or more actions are performed based upon a plurality of sets of data. A first value associated with performance of the one or more actions may be determined. A plurality of sources of the plurality of sets of data may be determined based upon the plurality of sets of data. A source of the plurality of sources may be associated with one or more sets of data of the plurality of sets of data. A plurality of values associated with the plurality of sources may be determined based upon the first value and/or the plurality of sets of data. A plurality of payment values associated with the plurality of sources may be generated based upon the plurality of values. A first payment value of the plurality of payment values may be associated with a first source of the plurality of sources. A second payment value of the plurality of payment values may be associated with a second source of the plurality of sources. A first payment associated with the first payment value may be transferred to a first account associated with the first source. A second payment associated with the second payment value may be transferred to a second account associated with the second source.

In another example, performance of one or more actions is detected. A plurality of sets of data used for the performance of the one or more actions may be determined. A first value associated with the performance of the one or more actions may be determined. A plurality of sources of the plurality of sets of data may be determined based upon the plurality of sets of data. A source of the plurality of sources may be associated with one or more sets of data of the plurality of sets of data. A plurality of values associated with the plurality of sources may be determined based upon the first value and/or the plurality of sets of data. A plurality of payment values associated with the plurality of sources may be generated based upon the plurality of values. A first payment value of the plurality of payment values may be associated with a first source of the plurality of sources. A second payment value of the plurality of payment values may be associated with a second source of the plurality of sources. A first payment associated with the first payment value may be transferred to a first account associated with the first source. A second payment associated with the second payment value may be transferred to a second account associated with the second source.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for determining values associated with sources of sets of data.

FIG. 5A is a diagram illustrating an exemplary system for determining values associated with sources of sets of data, where a client device presents and/or accesses an email interface.

FIG. 5B is a diagram illustrating an exemplary system for determining values associated with sources of sets of data, where a client device presents and/or accesses a first email.

FIG. 5C is a diagram illustrating an exemplary system for determining values associated with sources of sets of data, where an authorization message is received from a client device.

FIG. 5D is a diagram illustrating an exemplary system for determining values associated with sources of sets of data, where a payment is transferred to an account associated with a first user and/or a client device.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

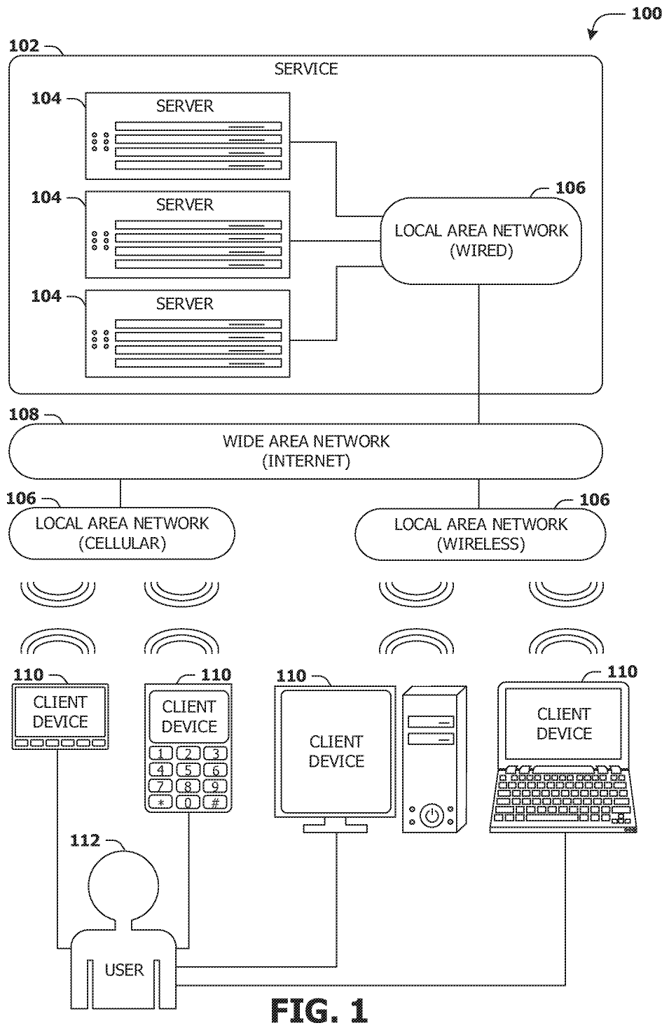

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

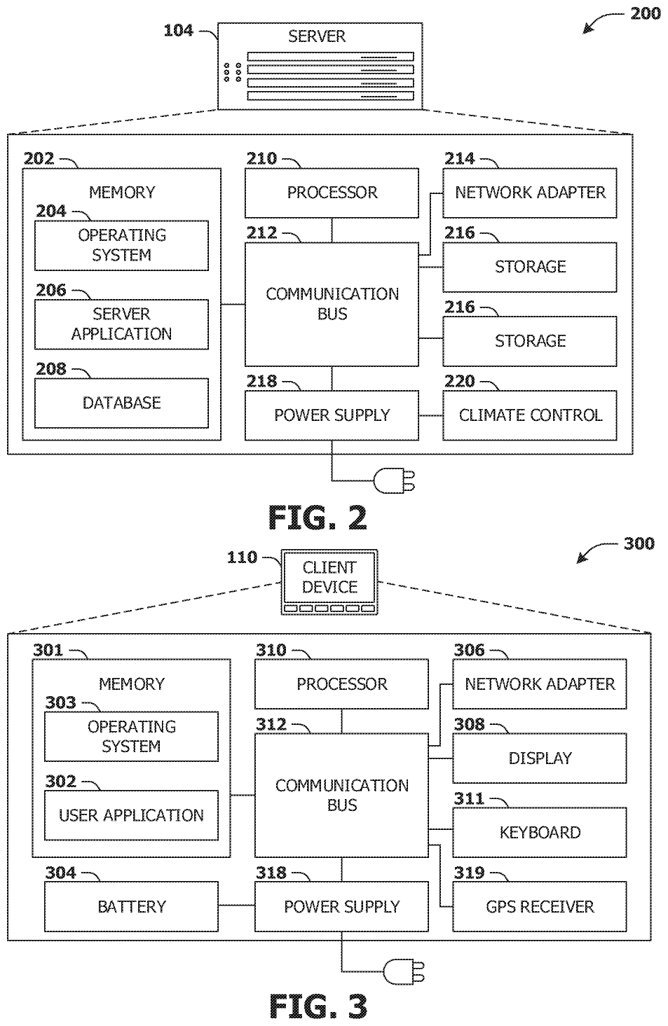

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for determining values associated with sources of sets of data are provided. Many systems utilize data about individuals to perform various functions, such as provide services and/or resources, select content for presentation to users and/or trade shares in an equity market. Performance of functions based upon the data may lead to profits and/or losses for an organization.

For example, one or more entities may provide data to a system. The system may analyze the data to make a decision and/or to perform one or more actions based upon the decision. In an example, the data may comprise one or more of user activity performed via a client device, one or more searches performed via the client device, one or more emails received via an email account, one or more messages received via the client device, etc. The system may determine one or more interests of a user based upon the data and/or the system may select a content item and/or provide the content item (e.g., an advertisement) for presentation via the client device based upon the one or more interests (e.g., the data).

The presentation of the content item may be associated with a revenue for an entity associated with the system (e.g., the entity may receive revenue based upon the presentation of the content item). In some cases, the one or more entities (that provided the data to the system) may require and/or desire compensation for providing the data (and/or providing authorization for the data to be used for analysis). For example, the user, whose user data is used for selecting the content item, may be one of the one or more entities. The compensation may correspond to a portion of the revenue and/or a portion of a profit associated with the revenue.

Thus, in accordance with one or more of the techniques presented herein, values associated with sources of sets of data are determined. In some examples, one or more actions are performed based upon a plurality of sets of data. A first value associated with performance of the one or more actions may be determined. A plurality of sources of the plurality of sets of data may be determined based upon the plurality of sets of data. A source of the plurality of sources may be associated with one or more sets of data of the plurality of sets of data. A plurality of values associated with the plurality of sources may be determined based upon the first value and/or the plurality of sets of data. A plurality of payment values associated with the plurality of sources may be generated based upon the plurality of values. A first payment value of the plurality of payment values may be associated with a first source of the plurality of sources. A second payment value of the plurality of payment values may be associated with a second source of the plurality of sources. A first payment associated with the first payment value may be transferred to a first account associated with the first source. A second payment associated with the second payment value may be transferred to a second account associated with the second source.

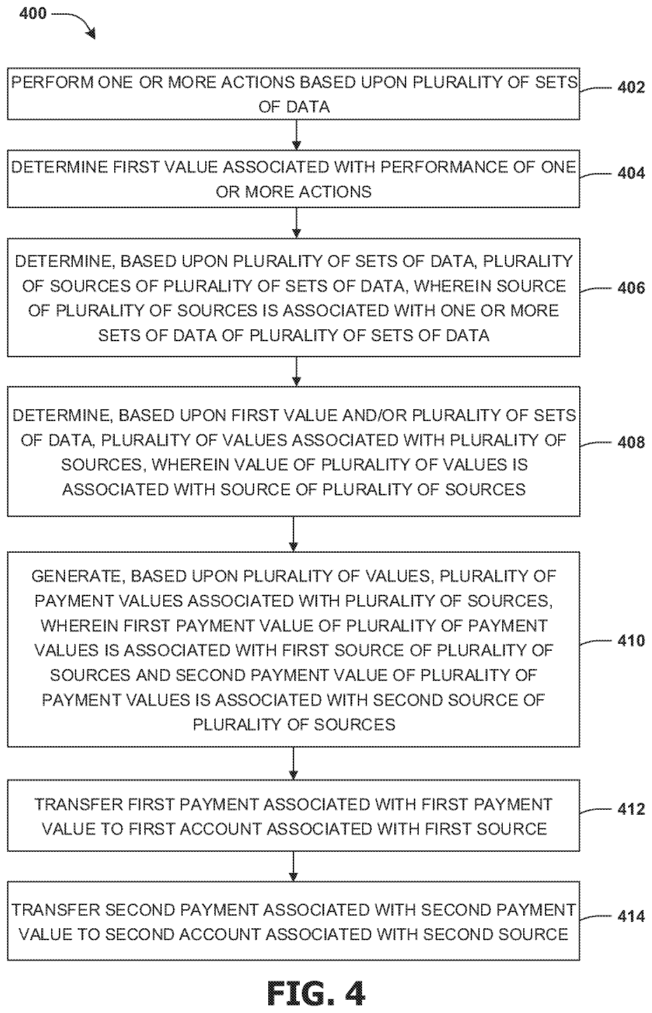

An embodiment of determining values associated with sources of sets of data is illustrated by an example method 400 of FIG. 4. At 402, one or more actions may be performed based upon a plurality of sets of data. In some examples, the one or more actions may be performed by a first system. In some examples, the one or more actions may be performed based upon the plurality of sets of data and/or one or more out-of-sample inputs.

In an example, performance of the one or more actions may comprise selecting one or more content items (e.g., advertisements and/or a different type of content) for presentation via one or more client devices. For example, the first system may correspond to a content system for presenting content via client devices. In some examples, the content system may be an advertisement system. Alternatively and/or additionally, the content system may provide content items to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application associated with the content system and/or within a game associated with the content system. Alternatively and/or additionally, a user may be required to watch and/or interact with the content item before the user can access content of a web page, utilize resources of an application and/or play a game.

In some examples, the content system may select the one or more content items for presentation via the one or more client devices based upon the plurality of sets of data. For example, the plurality of sets of data may be indicative of one or more of user activity performed via client devices, blogs and/or social media posts produced via client devices, searches performed via client devices, consumed content items (e.g., articles, videos, audio files, images, webpages, advertisements, emails, messages, etc. consumed by users), accessed content items (e.g., articles, videos, audio files, images, webpages, advertisements, emails, messages, etc. accessed by client devices), selected content items (e.g., articles, videos, audio files, images, webpages, advertisements, emails, messages, etc. selected via client devices), etc.

In some examples, performance of the one or more actions may comprise selecting a first content item for presentation via a first client device. In some examples, one or more sets of data of the plurality of sets of data may be associated with the first client device. For example, the one or more sets of data may be indicative of one or more of user activity performed via the first client device, one or more searches performed via the first client device (e.g., the one or more sets of data may comprise one or more queries associated with the one or more searches performed via a search engine), one or more consumed content items associated with the first client device, one or more accessed content items associated with the first client device, one or more selected content items associated with the first client device, etc. In some examples, one or more interests associated with a user of the first client device may be determined based upon the one or more sets of data. Alternatively and/or additionally, the first content item may be selected for presentation via the first client device based upon the one or more interests. Alternatively and/or additionally, a click probability may be determined based upon the one or more sets of data and/or the first content item. For example, the click probability may correspond to a probability of receiving a selection of the first content item responsive to presenting the first content item via the first client device. Alternatively and/or additionally, the click probability may correspond to a probability of a positive interaction with the first content item responsive to presenting the first content item via the first client device. In some examples, the first content item may be selected for presentation via the first client device based upon the click probability (and/or based upon other click probabilities associated with other content items in an auction).

Alternatively and/or additionally, the one or more out-of-sample inputs may be associated with user activity associated with the first client device. In some examples, the one or more out-of-sample inputs may correspond to a request for content. For example, the request for content may correspond to a request to provide content via an internet resource (e.g., a webpage, a mobile application, etc.). For example, the request for content may be indicative of the internet resource (e.g., the request for content may be indicative of a web address of the webpage and/or the mobile application). For example, the one or more out-of-sample inputs may be indicative of one or more of the internet resource, user activity performed via the first client device, one or more searches performed via the first client device, one or more consumed content items associated with the first client device, one or more accessed content items associated with the first client device, one or more selected content items associated with the first client device, etc. In some examples, the first content item may be selected for presentation via the first client device based upon the one or more out-of-sample inputs and/or the plurality of sets of data. For example, the plurality of sets of data may be compared with the one or more out-of-sample inputs to select the first content item for presentation via the first client device. For example, the click probability of the first content item may be determined based upon a comparison of the plurality of sets of data and the one or more out-of-sample inputs.

In another example, performance of the one or more actions may comprise trading one or more shares in an equity market. For example, the first system may correspond to a system for buying and/or selling shares in the equity market may be provided. Performance of the one or more actions may comprise buying the one or more shares in the equity market. Alternatively and/or additionally, the performance of the one or more actions may comprise selling the one or more shares in the equity market. Alternatively and/or additionally, the performance of the one or more actions may comprise maintaining the one or more shares in the equity market (e.g., neither buying nor selling the one or more shares based upon the plurality of sets of data). In some examples, the plurality of sets of data may be analyzed by the first system to determine whether to buy or sell shares of a business. For example, market research associated with the business may be performed and/or one or more economic forecasts associated with the business may be predicted by analyzing the plurality of sets of data. For example, the plurality of sets of data may be analyzed to predict whether a share price associated with shares of the business will increase and/or decrease. A decision of whether to buy or sell shares associated with the business may be made based upon the plurality of sets of data and/or the one or more out-of-sample inputs. For example, the one or more actions may be performed based upon the decision. For example, if it is predicted based upon the plurality of sets of data that the share price associated with shares of the business will increase, performance of the one or more actions may comprise buying one or more shares associated with the business in the equity market. Alternatively and/or additionally, if it is predicted based upon the plurality of sets of data that the share price associated with shares of the business will decrease, performance of the one or more actions may comprise selling one or more shares associated with the business in the equity market.

In the example where performance of the one or more actions comprises trading one or more shares in the equity market, the plurality of sets of data may be indicative of one or more of user activity related to the business performed via client devices (e.g., the user activity may be related to one or more of a brand associated with the business, a service provided by the business, a product provided by the business, etc.), blogs and/or social media posts related to the business, searches related to the business, consumed content items related to the business, accessed content items related to the business, selected content items related to the business, emails related to the business, etc. For example, one or more of a popularity associated with the business, a purchase rate associated with the business, an amount of revenue associated with the business, a rate at which products and/or services of the business are returned, a rate at which services and/or subscriptions associated with the business are cancelled, etc. may be determined based upon the plurality of sets of data. Alternatively and/or additionally, the one or more out-of-sample inputs may be indicative of a current share price associated with the business, a current sales amount, etc.

In an example, the business may correspond to a subscription based content provider. The plurality of sets of data may be indicative of emails and/or messages associated with purchases of subscriptions of the subscription based content provider and/or emails and/or messages associated with subscription cancellations of the subscription based content provider. For example, the plurality of sets of data may be determined by analyzing emails and/or messages to identify emails and/or messages comprising keywords indicative of subscription purchases (e.g., “we're glad you joined our content subscription”) and/or emails and/or messages comprising keywords indicative of subscription cancellations (e.g., “we're sorry to see you leave our content subscription”). In some examples, each set of data of the plurality of sets of data may be indicative of an instance of a subscription purchase and/or a subscription cancellation. A quantity of subscription purchases and/or a quantity of subscription cancellations may be determined based upon the plurality of sets of data. The quantity of subscription purchases and/or the quantity of subscription cancellations may be used to predict whether the share price associated with shares of the business will increase and/or decrease. The one or more actions (e.g., buying and/or selling one or more shares associated with the business) may be performed based upon the quantity of subscription purchases and/or the quantity of subscription cancellations (and/or based upon a prediction of whether the share price associated with shares of the business will increase and/or decrease).

In another example, performance of the one or more actions may comprise performing a clinical trial and/or developing one or more medical products based upon the plurality of sets of data. In some examples, the plurality of sets of data may be comprise medical records, such as genealogical data, medical data and/or genetic data associated with individuals. The clinical trial may be performed and/or the one or more medical products may be designed based upon the medical records.

In another example, performance of the one or more actions may comprise setting an insurance rate for individuals based upon the plurality of sets of data. For example, the plurality of sets of data may comprise records, such as medical records, automobile accident records, etc. associated with a type of insurance associated with the insurance rate. The insurance rate may be set based upon the records.

In some examples, performance of the one or more actions may be detected. For example, an indication of performance of the one or more actions may be received and/or identified. Alternatively and/or additionally, the plurality of sets of data used for performance of the one or more actions may be determined. For example, an indication of the plurality of sets of data may be received and/or identified.

At 404, a first value associated with performance of the one or more actions may be determined. In some examples, the first value may be determined after performance of the one or more actions. Alternatively and/or additionally, the first value may be determined (and/or predicted) prior to performance of the one or more actions.

In some examples, the first value may be determined based upon an amount of revenue (and/or a predicted amount of revenue) associated with performance of the one or more actions. For example, the amount of revenue (and/or the predicted amount of revenue) may correspond to revenue received as a result of performing the one or more actions. In some examples, the first value may correspond to the amount of revenue (and/or the predicted amount of revenue). Alternatively and/or additionally, the first value may be determined based upon a cost of performance of the one or more actions and/or a predicted cost of performance of the one or more actions (e.g., expenses and/or work associated with performing the one or more actions).

In an example, the first value may be determined by performing one or more operations (e.g., mathematical operations) using the amount of revenue (and/or the predicted amount of revenue) and/or the cost (and/or the predicted cost). For example, the first value may correspond to the amount of revenue (and/or the predicted amount of revenue) subtracted by the cost (and/or the predicted cost).

Alternatively and/or additionally, a second value may be determined by performing one or more operations (e.g., mathematical operations) using the amount of revenue (and/or the predicted amount of revenue) and/or the cost (and/or the predicted cost) (and/or one or more other values). For example, the second value may correspond to the amount of revenue (and/or the predicted amount of revenue) subtracted by the cost (and/or the predicted cost). For example, the second value may correspond to a profit associated with the one or more actions. In some examples, the first value may be determined based upon the second value. For example, the first value may correspond to a proportion of the second value. In some examples, the first value may be determined by performing one or more operations (e.g., mathematical operations) using the second value and/or a third value. In some examples, the first value is less than the second value. Alternatively and/or additionally, the first value may correspond to an excess profit of the profit (e.g., the proportion of the second value).

In the example where performance of the one or more actions comprises selection of one or more content items for presentation via one or more client devices, the amount of revenue may correspond to an amount of compensation received from one or more entities for one or more of presentation of the one or more content items via the one or more client devices, advertisement impressions associated with the one or more content items, selections of the one or more content items via the one or more client devices, etc. Alternatively and/or additionally, the loss may be associated with one or more of bandwidth used for transmission of content items to client devices, technical support required for selecting content items and/or transmitting content items to client devices, etc.

In the example where performance of the one or more actions comprises trading the one or more shares in the equity market, the first value may be determined based upon a change in the share price of the one or more shares. In an example where performance of the one or more actions comprises buying and/or not selling the one or more shares based upon the plurality of sets of data, the first value may be determined based upon an increase in the share price and/or a quantity of shares of the one or more shares. Alternatively and/or additionally, in an example where performance of the one or more actions comprises selling and/or not buying the one or more shares based upon the plurality of sets of data, the first value may be determined based upon a decrease in the share price and/or a quantity of shares of the one or more shares.

In the example where performance of the one or more actions comprises performing the clinical trial and/or development of the one or more medical products, the first value may be determined based upon one or more of whether the one or more medical products are successfully developed, prices associated with the one or more medical products, an increase in revenue and/or a decrease in losses associated with performance of the one or more actions based upon the plurality of sets of data, etc.

In the example where performance of the one or more actions comprises setting the insurance rate, the first value may be determined based upon an increase in revenue and/or a decrease in losses associated with the insurance rate being set based upon the plurality of sets of data.

In some examples, the first value may be a positive value (e.g., the first value may be associated with the amount of revenue, the profit and/or the excess profit). Alternatively and/or additionally, the first value may be zero. Alternatively and/or additionally, the first value may be a negative value. For example, the first value may be associated with a decrease in revenue and/or an increase in losses associated with performance of the one or more actions based upon the plurality of sets of data.

At 406, a plurality of sources of the plurality of sets of data may be determined based upon the plurality of sets of data. For example, a source of the plurality of sources may be associated with one or more sets of data of the plurality of sets of data. In some examples, an exemplary source of the plurality of sources may be associated with an exemplary entity and/or an exemplary system that provides one or more exemplary sets of data, of the plurality of sets of data, to the first system for analysis of the one or more exemplary sets of data and/or for performance of the one or more actions (and/or one or more other actions) based upon the one or more exemplary sets of data. Alternatively and/or additionally, an exemplary source of the plurality of sources may be associated with an exemplary entity and/or an exemplary system that provides authorization, to the first system, for analysis of the one or more exemplary sets of data and/or for performance of the one or more actions (and/or one or more other actions) based upon the one or more exemplary sets of data.

In some examples, prior to performing the one or more actions, a graphical user interface of a first exemplary client device associated with a first exemplary source of the plurality of sources may be controlled to display a request for access to one or more sets of data of the first exemplary source. In some examples, the request may correspond to a request for an entity (e.g., an individual and/or an organization), associated with the first exemplary source, to authorize the first system to analyze the one or more sets of data and/or to perform the one or more actions (and/or one or more other actions) based upon the one or more sets of data. In some examples, the request may comprise a first selectable input. The first selectable input may be associated with providing the first system with access to the one or more sets of data. Alternatively and/or additionally, the first selectable input may be associated with providing authorization for the first system to analyze the one or more sets of data and/or to perform the one or more actions (and/or one or more other actions) based upon the one or more sets of data. In some examples, responsive to a selection of the first selectable input, an authorization message may be received from the first exemplary client device. Alternatively and/or additionally, responsive to a selection of the first selectable input, the first system may be authorized to analyze the one or more sets of data and/or to perform the one or more actions (and/or one or more other actions) based upon the one or more sets of data.

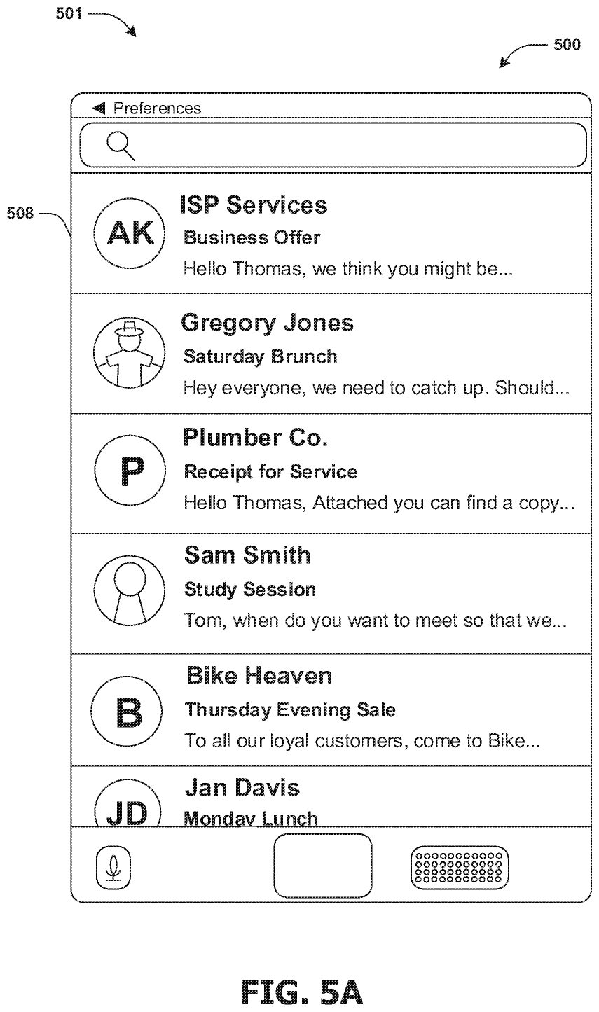

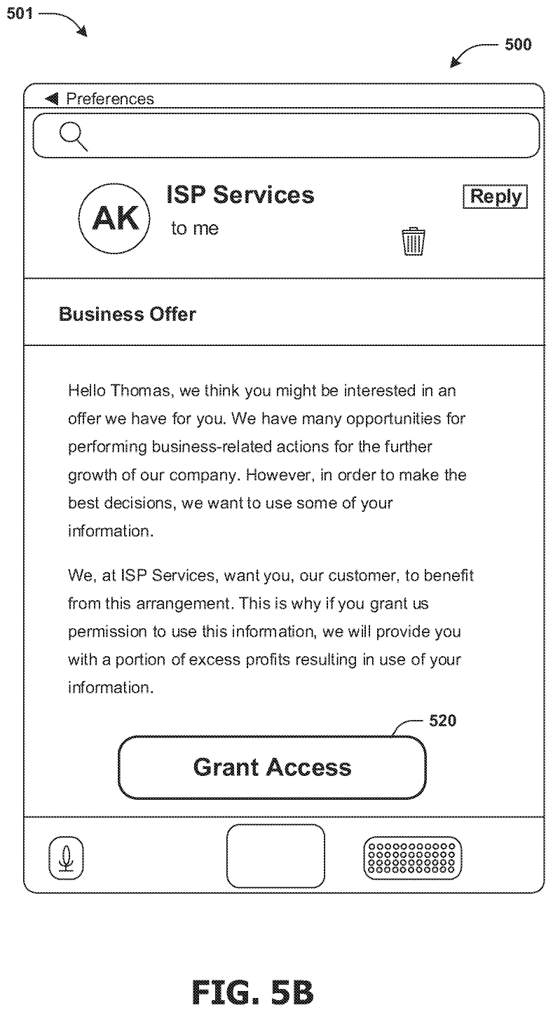

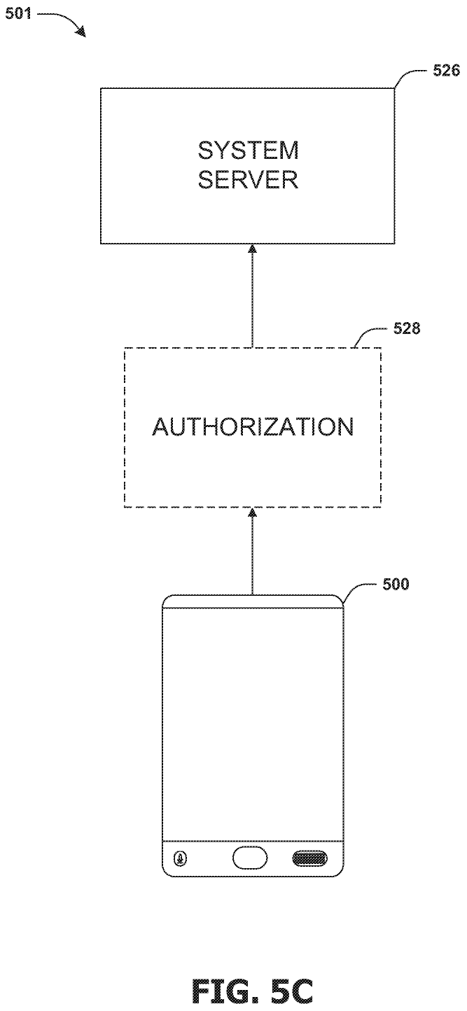

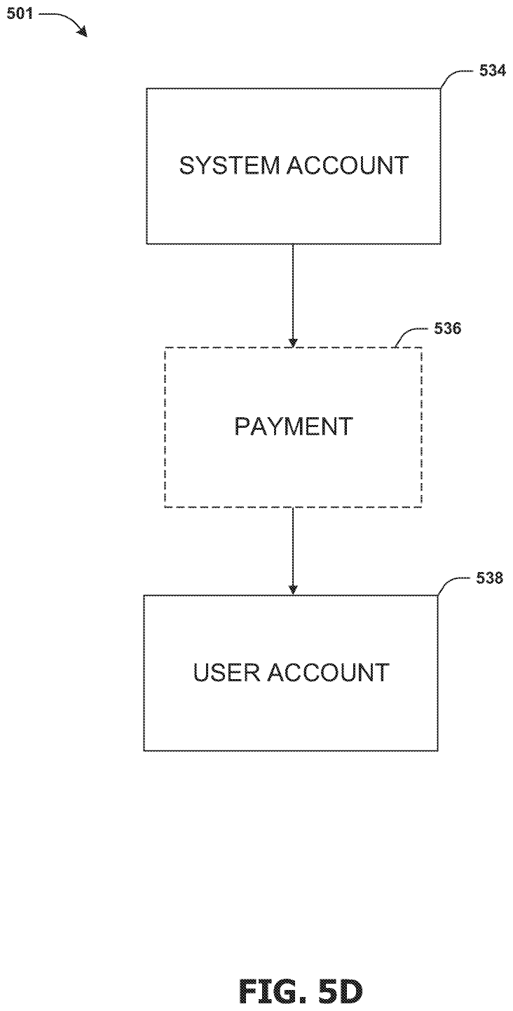

FIGS. 5A-5D illustrate an exemplary system 501 for determining values associated with sources of sets of data. A first user, such as user Jennifer, and/or a client device 500 (e.g., the first exemplary client device) associated with the first user may access and/or interact with an email interface that provides a platform for viewing, receiving and/or sending emails.

FIG. 5A illustrates the client device 500 presenting and/or accessing the email interface. In some examples, the email interface may display an email list comprising a plurality of email items corresponding to received emails. In some examples, a first email item 508 of the email list may be selected. Responsive to a selection of the first email item 508, a first email may be presented.

FIG. 5B illustrates the client device 500 presenting and/or accessing the first email. In some examples, the first email may correspond to an exemplary request for access to one or more exemplary sets of data associated with the client device 500. In some examples, the first email may correspond to a request for the first user, associated with the client device 500, to authorize the first system to analyze the one or more exemplary sets of data and/or to perform the one or more actions (and/or one or more other actions) based upon the one or more exemplary sets of data. In some examples, the first email may comprise a selectable input 520 (e.g., the first selectable input). In some examples, responsive to a selection of the selectable input 520, an authorization message 528 may be received from the client device 500.

FIG. 5C illustrates the authorization message 528 being received from the client device 500. For example, the client device 500 may transmit the authorization message 528 to a server 526 associated with the first system. In some examples, responsive to receiving the authorization message 528, the first system may be authorized to analyze the one or more exemplary sets of data and/or to perform the one or more actions (and/or one or more other actions) based upon the one or more exemplary sets of data.

In some examples, the request may be indicative of one or more characteristics of data associated with the request. For example, the first system may access and/or may be authorized to analyze data associated with the one or more characteristics of data (responsive to a selection of the first selectable input). For example, the one or more characteristics of data may correspond to one or more of a time associated with requested data, a type of data associated with the requested data, one or more features associated with the requested data, etc. For example, the time associated with the requested data may correspond to a first time period within which the requested data corresponds to (e.g., searches performed during the first time period, emails received and/or sent during the first time period, etc.). Alternatively and/or additionally, the type of data associated with the requested data may be correspond to one or more of email data, search data, content selection data, etc. Alternatively and/or additionally, the one or more features associated with the requested data may correspond to one or more topics and/or subjects associated with the requested data and/or one or more keywords associated with the requested data.

Alternatively and/or additionally, the request may be indicative of a scope of use of data associated with a requested use of data (e.g., a scope within which the requested data may be used). For example, the scope may correspond to one or more of a time associated with the requested use of data, one or more functions associated with the requested use of data, etc. For example, the time associated with the requested use of data may correspond to a second time period within which the first system is authorized to use the requested data. Alternatively and/or additionally, the one or more functions associated with the requested use of data may correspond to one or more types of actions for which the first system is authorized to use the requested data (e.g., the first system may be authorized to analyze the requested data merely for performance of actions and/or operations pertaining to the one or more types of actions).

In an example, the request may be indicative of the type of data corresponding to email and/or message data. Alternatively and/or additionally, the request may be indicative of the first time period. For example, the requested data may correspond to emails and/or messages received and/or sent within the first time period, such as a week, a month, etc. Alternatively and/or additionally, the request may be indicative of the one or more features associated with the requested data corresponding to emails and/or messages associated with subscription purchases and/or subscription cancellations of the subscription based content provider. In an example, the request may comprise “We would like to have access to your emails pertaining to subscription purchases and/or subscription cancellations in the past month”. Alternatively and/or additionally, the request may be indicative of the second time period. For example, the second time period may be indicative of the first system being authorized to use the requested data merely within the second period of time (e.g., the first system may be authorized to analyze the requested data merely within the second period of time responsive to a selection of the first selectable input). Alternatively and/or additionally, the request may be indicative of the one or more functions (associated with the requested use of data). For example, the one or more functions may be indicative of the requested data being used to perform economic forecasting and/or to predict changes in one or more share prices associated with one or more businesses. In an example, the request may comprise “We will use this data for predicting changes in stock prices of subscription based content providers”.

In some examples, the request may correspond to an exemplary email transmitted to an exemplary email account associated with the first exemplary client device. Alternatively and/or additionally, the request may correspond to an exemplary message transmitted to the first exemplary client device. For example, the exemplary email and/or the exemplary message may comprise the first selectable input. Alternatively and/or additionally, the first selectable input may be displayed via an authorization interface displayed via the first exemplary client device. In some examples, access to data associated with the first exemplary source may be provided to the first system via the authorization interface. Alternatively and/or additionally, authorization to use the data for performance of the one or more actions (and/or one or more other actions) may be provided to the first system via the authorization interface. For example, one or more types of data of data authorized to be analyzed and/or used for performance of actions, a time period associated with the data, one or more features associated with the data, a time period associated with use of the data, and/or one or more functions associated with the data may be input via the authorization interface.

In some examples, the one or more sets of data may be received from the first exemplary client device associated with the first exemplary source. Alternatively and/or additionally, the one or more sets of data may be comprised within a database associated with the first system. For example, responsive to receiving the authorization message from the first exemplary client device, the first system may retrieve the one or more sets of data from the database associated with the first system and/or generate the plurality of sets of data with the one or more sets of data. For example, the database associated with the first system may be analyzed based upon the first period of time, the type of data and/or the one or more features to identify the one or more sets of data corresponding to the first period of time, the type of data and/or the one or more features.

Alternatively and/or additionally, the one or more sets of data may be received from a second system different than the first exemplary client device. For example, responsive to the first system being authorized to access and/or analyze the one or more sets of data for performance of the one or more actions (and/or one or more other actions), the first system may retrieve the one or more sets of data from the second system. For example, the first system may transmit instructions to the second system to transmit the one or more sets of data to the first system. For example, responsive to receiving the instructions, the second system may analyze a database to identify the one or more sets of data and/or the second system may provide the one or more sets of data to the first system. In an example, the one or more sets of data may correspond to medical records and/or the second system may correspond to a system maintaining a database of medical records. In some examples, responsive to the second system receiving the instructions and/or responsive to the second system determining that the first system is authorized to access the medical records, the second system may transmit the medical records associated with the first exemplary source to the first system.

In some examples, an authorization tag may be assigned to the one or more sets of data. For example, the authorization tag may be indicative of the first system being authorized to analyze the one or more sets of data and/or to perform the one or more actions (and/or one or more other actions) based upon the one or more sets of data. Alternatively and/or additionally, the authorization tag may be indicative of the second time period associated with the one or more sets of data (and/or an expiration time associated with the second time period when authorization for analyzing the one or more sets of data is expired) and/or the one or more functions associated with the one or more sets of data. Alternatively and/or additionally, the authorization tag may be indicative of the first exemplary source. For example, the authorization tag may be indicative of one or more of account information, payment information, identification information associated with an individual and/or a business associated with the first exemplary source, an email address associated with the first exemplary source, a phone number associated with the first exemplary source, etc.

Alternatively and/or additionally, the authorization interface may comprise a second selectable input associated with not providing the first system with access to the one or more sets of data and/or not authorizing the first system to use the one or more sets of data for performance of the one or more actions (and/or for performance of other actions). In some examples, responsive to receiving a selection of the second selectable input, the plurality of sets of data may be generated without the one or more sets of data.

In some examples, the plurality of sets of data may be generated based upon a second plurality of sets of data comprised within one or more databases. In some examples, the second plurality of sets of data may be evaluated to determine whether analysis of each set of data of the second plurality of sets of data is authorized. For example, the second plurality of sets of data may be evaluated based upon authorization tags associated with the second plurality of sets of data. In some examples, the first system may determine that analysis of first sets of data of the second plurality of sets of data (for performance of the one or more actions) is authorized and/or that analysis of second sets of data of the second plurality of sets of data (for performance of the one or more actions) is not authorized. The plurality of sets of data may be generated with the first sets of data and/or without the second sets of data (e.g., the first sets of data may be selected for inclusion in the plurality of sets of data and/or the second sets of data may not be selected for inclusion in the plurality of sets of data).

In some examples, the plurality of sources may be determined based upon a plurality of authorization tags and/or a plurality of identification tags associated with the plurality of sets of data. For example, the plurality of authorization tags and/or the plurality of identification tags may be indicative of the plurality of sources.

At 408, a plurality of values associated with the plurality of sources may be determined based upon the first value and/or the plurality of sets of data. For example, a value of the plurality of values may be associated with a source of the plurality of sources. In some examples, the plurality of values may comprise a plurality of Shapley values. Alternatively and/or additionally, the plurality of values may comprise a plurality of Owen values. In some examples, the plurality of values merely comprises the plurality of Shapley values (without Owen values). Alternatively and/or additionally, the plurality of values merely comprises the plurality of Owen values (without Shapley values). Alternatively and/or additionally, the plurality of values may comprise (both) the plurality of Shapley values and the plurality of Owen values.

In some examples, Shapley values may be determined in association with first sources of the plurality of sources that are each associated with (and/or provide) a single set of data of the plurality of sets of data. For example, each source of the first sources of the plurality of sources may be associated with (and/or may provide) a single set of data of the plurality of sets of data. In some examples, the first system may determine that an exemplary source is associated with a single set of data of the plurality of sets of data. For example, the exemplary source may be associated with and/or may provide merely the single set of data. For example, the exemplary source may not be associated with and/or may not provide any set of data of the plurality of sets of data (used for performance of the one or more actions) other than the single set of data. In an example, the exemplary source may be associated with a user and/or a client device that provides the single set of data to the first system and/or authorizes the first system to analyze the single set of data for performance of the one or more actions. In some examples, responsive to determining that the exemplary source is associated with the single set of data, a Shapley value, of the plurality of values, associated with the exemplary source may be determined. In some examples, the Shapley value may be indicative of an exemplary value of the single set of data for performance of the one or more actions associated with the first value and/or for making a decision based upon which the one or more actions are performed.

In some examples, Owen values may be determined in association with second sources of the plurality of sources that are each associated with (and/or provide) two or more sets of data (e.g., multiple sets of data) of the plurality of sets of data. For example, each source of the second sources of the plurality of sources may be associated with (and/or may provide) two or more sets of data of the plurality of sets of data. In some examples, the first system may determine that an exemplary source is associated with two or more sets of data of the plurality of sets of data. For example, the exemplary source may provide the two or more sets of data to the first system and/or may authorize the first system to analyze the two or more sets of data for performance of the one or more actions. In an example, the exemplary source may be associated with an exemplary system, such as one or more of an exemplary email system, an exemplary content system, an exemplary medical database system, etc. that provides the two or more sets of data to the first system and/or authorizes the first system to analyze the two or more sets of data for performance of the one or more actions. For example, the two or more sets of data may correspond to an exemplary plurality of sets of data associated with one or more of demographic information (e.g., one or more of names of individuals, genders of individuals, locations of individuals, etc.), user activity, email activity, medical records, etc. associated with a plurality of individuals (e.g., the plurality of individuals may correspond to users of one or more of the exemplary email system, the exemplary content system, the exemplary medical database system, etc.). In some examples, the two or more sets of data may comprise aggregated data (e.g., the aggregated data may be indicative of the exemplary plurality of sets of data associated with the plurality of individuals). In some examples, responsive to determining that the exemplary source is associated with the two or more sets of data, an Owen value, of the plurality of values, associated with the exemplary source may be determined. In some examples, the Owen value may be indicative of an exemplary value of the two or more sets of data for performance of the one or more actions associated with the first value and/or for making a decision based upon which the one or more actions are performed.

In some examples, a Shapley value and/or an Owen value may correspond to an exemplary value corresponding to one or more sets of data provided by a source and/or may be determined based upon a marginal increase in value and/or profit that occurs upon adding the one or more sets of data to the plurality of sets of data, averaged over many orders in which sets of data associated with the plurality of sources may be included in the plurality of sets of data. Due to there being a large amount of possible orderings for which sets of data associated with the plurality of sources may be included in the plurality of sets of data, to determine a Shapley value and/or an Owen value associated with one or more sets of data of the plurality of sets of data is infeasible if the definition of the Shapley value and/or the definition of the Owen value is used (e.g., calculations and/or computations required to determine the Shapley value and/or the Owen value may take years and/or centuries to perform). Thus, using some existing techniques for determining Shapley values and/or Owen values for determining the plurality of values associated with the plurality of sources may be infeasible.

Techniques are provided herein that may be used to more efficiently determine Shapley values of the plurality of values and/or Owen values of the plurality of values. For example, by implementing one or more of the techniques provided herein, Shapley values and/or Owen values of the plurality of values may be determined in merely seconds (and/or microseconds), even where a quantity of sets of data of the plurality of sets of data and/or a quantity of sources of the plurality of sources are very high.

In the present disclosure, combinations may be presented using the following format:

$$( \begin{matrix}a \\ b\end{matrix} ) .$$

It may be assumed that

$$( \begin{matrix}a \\ b\end{matrix} )$$

is zero if b<0 and/or if b>a.

In some examples, a Shapley value of a source of the plurality of sources may be determined by averaging over all possible orders in which a set of data associated with the source may be included in the plurality of sets of data. For example, a general equation for determining the Shapley value for a set of data i corresponds to E_{σ∈P}[v(Sᵢ(σ)∪{i})−v(Sᵢ(σ))], where P is a set of permutations of 1, . . . , n for n sets of data, a denotes permutations, Sᵢ(σ) corresponds to one or more sets of data included before i in a and/or v(S) corresponds to a value (e.g., the first value) if sets of data indexed by S are included in the plurality of sets of data and/or other sets of data are not included in the plurality of sets of data.

In some examples, an Owen value of a source of the plurality of sources (associated with a group of sets of data of the plurality of sets of data) may be determined by averaging over permutations of groups of sets of data of the plurality of sets of data and/or averaging over sets of data of the group of sets of data associated with the source to determine a set of values associated with the group of sets of data associated with the source (e.g., each value of the set of values may be associated with a set of data of the group of sets of data). In some examples, the Owen value of the source corresponds to a sum of the set of values. For example, where m is a quantity of groups of sets of data (wherein each group of sets of data has two or more sets of data associated with a source of the plurality of sources) and/or C₁, . . . , Cₘ are sets of indices associated with sets of data in the groups of sets of data, a general equation for determining an Owen value for a set of data i in the group of sets of data h corresponds to E_{σ}_{_{C}}_{∈P}_{_{C}}E_{σ}_{ₕ}_{∈P}_{ₕ}[v(∪_{j∈S}_{ₕ}_{(σ}_{_{C}}₎Cⱼ∪Sᵢ(σₕ)∪{i})−v(∪_{j∈S}_{ₕ}_{(σ}_{_{C}}₎Cⱼ∪Sᵢ(σₕ))], where P_{C} is a set of permutations of 1, . . . , m, Sₕ(σ_{C}) is a set of entries before h in permutation σ_{C}, Pₕ is a set of permutations of indices of sets of data in Cₕ and/or Sᵢ(σₕ) is a set of indices before i in a. In some examples, an Owen value of the source and/or the group of sets of data associated with the source corresponds to a sum of Owen values of sets of data of the group of sets of data over the sets of data of the group of sets of data.

In some examples, the one or more actions may be performed by performing a frequency-based process. In the frequency-based process, the plurality of sets of data may be associated with one or more labels. For example, a set of data of the plurality of sets of data may be assigned a label of one or more labels. In some examples, an output may be generated based upon an out-of-sample input, the one or more labels and/or the plurality of sets of data. For example, the output may be generated based upon the out-of-sample input and/or one or more frequencies associated with the one or more labels in the plurality of sets of data. For example, a frequency, of the one or more frequencies, associated with a label of the one or more labels may be associated with and/or determined based upon a quantity of sets of data of the plurality of sets of data that are assigned the label.

In some examples, the output may correspond to a classification, a decision and/or a score. In some examples, the one or more actions may be performed based upon the output. In some examples, the output may be generated based upon the out-of-sample input and/or the one or more frequencies associated with the one or more labels in the plurality of sets of data, using one or more machine learning techniques (e.g., a machine learning model may be trained using the plurality of sets of data and/or used to generate the output). In some examples, the output may be determined based upon a label associated with a highest frequency of the one or more frequencies. Alternatively and/or additionally, the output may be indicative of the label associated with the highest frequency of the one or more frequencies. Alternatively and/or additionally, the out-of-sample input may be assigned the label associated with the highest frequency of the one or more frequencies. Alternatively and/or additionally, the output may be generated based upon the label responsive to a determination that the highest frequency, of the one or more frequencies, associated with the label, exceeds a frequency threshold. Alternatively and/or additionally, the output may be generated based upon the label responsive to a determination that a difference between the highest frequency and one or more other frequencies of the one or more frequencies is higher than a threshold difference.

Alternatively and/or additionally, a lower confidence bound and/or a higher confidence bound on a probability of the label associated with the output may be determined based upon the one or more frequencies. Alternatively and/or additionally, the output may be indicative of the lower confidence bound and/or the higher confidence bound on the probability of the label associated with the output. Alternatively and/or additionally, a Bayesian estimate of the probability of the label may be determined based upon the one or more frequencies. Alternatively and/or additionally, a smoothed output, such as a sigmoid, applied to a relative frequency of a label, may be determined. Alternatively and/or additionally, the output may be generated based upon an estimation procedure performed based upon the relative frequency and/or a quantity of sets of data.

In some examples, a third plurality of sets of data, comprising the plurality of sets of data, may be separated (and/or clustered) into clusters of sets of data of the third plurality of sets of data. In some examples, the third plurality of sets of data may be separated into the clusters of sets of data using one or more histograms and/or one or more trees. In some examples, rather than generating the output based upon the out-of-sample input and the third plurality of sets of data, a first cluster of sets of data may be selected from the clusters of sets of data for generation of the output in association with the out-of-sample input. In some examples, the first cluster of sets of data may correspond to the plurality of sets of data. For example, the first cluster of sets of data may be selected based upon a comparison of the out-of-sample input with the clusters of sets of data of the plurality of sets of data (e.g., the out-of-sample input may match the first cluster of sets of data). For example, the output may be generated based upon the out-of-sample input and/or one or more frequencies associated with one or more labels in the first cluster of sets of data.

In an example where the plurality of sets of data are associated with emails and/or messages associated with subscription purchases associated with a subscription based content provider and/or subscription cancellations of the subscription based content provider, first sets of data of the plurality of sets of data may be assigned a first label associated with subscription purchases and/or second sets of data of the plurality of sets of data may be assigned a second label associated with subscription cancellations. In some examples, an output (e.g., a prediction of a change in share price associated with the subscription based content provider) may be determined based upon frequencies of the first sets of data and/or the second sets of data.

A first example for determining Shapley values for the plurality of sets of data is provided. One or more of the techniques presented in the first example for determining Shapley values may be implemented in embodiments using a frequency-based process and/or a different technique. An out-of-sample input x may be provided. A label y may correspond to the out-of-sample input x. In some examples, the label y may not be known when the out-of-sample input x is provided and/or an output is generated based upon the out-of-sample input x and/or the plurality of sets of data. In some examples, the output may be generated based upon the plurality of sets of data and/or the out-of-sample input x. In an example where the plurality of sets of data corresponds to a cluster of sets of data of the third plurality of sets of data, Shapley values associated with sets of data of the third plurality of sets of data that are not included in the plurality of sets of data may be zero (e.g., sets of data not included in the plurality of sets of data may not be used for generating the output). In some examples, a Shapley value associated with a set of data used for generating two or more outputs based upon two or more out-of-sample inputs may correspond to a sum of two or more Shapley values associated with the set of data corresponding to generating the two or more outputs.

In some examples, n corresponds to a quantity of sets of data of the plurality of sets of data. In some examples, 1, . . . , n corresponds to an index of sets of data of the plurality of sets of data. The first example for determining Shapley values may correspond to a binary classification example, where two labels are associated with sets of data of the plurality of sets of data. However, embodiments are contemplated where more than two labels are associated the plurality of sets of data, and one or more of the techniques presented herein may be used for determining Shapley values where more than two labels are associated with the plurality of sets of data. In some examples, for each set of data i∈{1, . . . , n}, a(i)=1 and/or b(i)=0 if a label of the set of data i equals the label y and/or a(i)=0 and/or b(i)=1, otherwise (e.g., if the label of the set of data i does not equal the label y, a(i)=0 and/or b(i)=1).

In some examples, A corresponds to a set of indices of sets of data of the plurality of sets of data that are assigned the label y (and/or are associated with a label equal to label y), excluding the set of data i. In some examples, B corresponds to a set of indices of sets of data of the plurality of sets of data assigned a second label different than label y, excluding the set of data i. In some examples, v(a,b) corresponds to a value of an action performed based upon the out-of-sample input x, based upon a version of the output that would result if the plurality of sets of data comprises a sets of data that are assigned the label y and/or b sets of data that are not assigned the label y. In some examples, Δᵢv(a,b) corresponds to a change in value (with respect to v(a,b)) based upon adding the set of data i to the plurality of sets of data, determining the output based upon the plurality of sets of data including the set of data i, and/or performing an action (e.g., the one or more actions) based upon the output. In some examples, given |A|=a and/or |B|=b, Δᵢv(a,b)=v(a+a(i), b+b(i))−v(a,b). In some examples, R corresponds to a set of (a,b) pairs for which adding the set of data i changes a value (of an action performed based upon an output generated based upon the plurality of sets of data), where R={(a,b)|Δᵢv(a,b)≠0}. In some examples, R is referred to as a critical set. In some examples, a Shapley value associated with the set of data ion the out-of-sample input x with the label y corresponds to

$${Σ}_{( a , b ) ∈ R} \frac{1}{n} {( \begin{matrix}n - 1 \\ a + b\end{matrix} )}^{- 1} ( \begin{matrix}\vert A \vert \\ a\end{matrix} ) ( \begin{matrix}\vert B \vert \\ b\end{matrix} ) {Δ}_{i} v ( a , b ) .$$

In an example scenario, an exemplary output may be generated based upon an exemplary label of the plurality of sets of data. For example, the exemplary label may correspond to a label assigned to exemplary sets of data of the plurality of sets of data, where the exemplary sets of data associated with the exemplary label meet an exemplary threshold. In some examples, the exemplary threshold may correspond to an exemplary threshold quantity of sets of data (e.g., the exemplary sets of data may meet the exemplary threshold if an exemplary quantity of sets of data of the exemplary sets of data meets the exemplary threshold quantity of sets of data). In some examples, the exemplary threshold may correspond to an exemplary threshold proportion of sets of data of the plurality of sets of data (e.g., the exemplary sets of data may meet the exemplary threshold if a proportion of sets of data of the exemplary sets of data in the plurality of sets of data meets the exemplary threshold proportion of sets of data). In some examples, the exemplary sets of data may meet the exemplary threshold if the exemplary sets of data correspond to a majority of the plurality of sets of data.

In the example scenario, the output may not be generated (and/or the output may be generated without a label of the one or more labels associated with the plurality of sets of data) responsive to determining that sets of data associated with each label of the one or more labels do not meet the exemplary threshold. In some examples, the output may be indicative of a classification associated with the majority label. In some examples, the output may be analyzed and/or compared with data (e.g., data that may be available after generation of the output) to determine whether the output and/or the classification is correct.

In the example scenario, if the output and/or the classification is correct, a value of performing an action (and/or not performing an action) based upon the output may be determined to be 100 (e.g., the output and/or the classification may be correct if the output and/or the classification is indicative of the label y). Alternatively and/or additionally, if the output and/or the classification is incorrect, a value of performing an action (and/or not performing an action) based upon the output may be determined to be −500 (e.g., the output and/or the classification may be correct if the output and/or the classification is indicative of a label different than the label y). Alternatively and/or additionally, if the output and/or the classification are not generated (and/or are generated without a label), a value of performing an action (and/or not performing an action) based upon the output and/or the classification not being generated (and/or based upon the output generated without a label) may be determined to be 0.

In the example scenario, the set of data i may be associated with the label y. In some examples, if a=b, then an addition of the set of data i to the plurality of sets of data with a sets of data assigned to the label y and/or b sets of data not assigned to the label y causes a correct output and/or a correct classification to be generated (as compared with no output if the set of data i is not added to the plurality of sets of data) (e.g., the addition of the set of data i to the plurality of sets of data causes a gain of 100). Alternatively and/or additionally, if a=b−1, then an addition of the set of data i to the plurality of sets of data may cause an output and/or a classification not to be generated (as compared with an incorrect output and/or an incorrect classification being generated if the set of data i is not added to the plurality of sets of data) (e.g., the addition of the set of data i to the plurality of sets of data causes a gain of 500). In some examples, R={(a,b)|a=b}∪{(a,b)|a=b−1} and/or the Shapley value of the set of data i is

$$\frac{100}{n} {{Σ}_{\{ ( a , b ) \vert a = b \}} ( \begin{matrix}n - 1 \\ a + b\end{matrix} )}^{- 1} ( \begin{matrix}\vert A \vert \\ a\end{matrix} ) ( \begin{matrix}\vert B \vert \\ b\end{matrix} ) + \frac{500}{n} {{Σ}_{\{ ( a , b ) \vert a = b - 1 \}} ( \begin{matrix}n - 1 \\ a + b\end{matrix} )}^{- 1} ( \begin{matrix}\vert A \vert \\ a\end{matrix} ) ( \begin{matrix}\vert B \vert \\ b\end{matrix} ) .$$

In the example scenario, the set of data i may be associated with a label different than the label y. In some examples, if a=b+1, then an addition of the set of data i to the plurality of sets of data with a sets of data assigned to the label y and/or b sets of data not assigned to the label y may cause an output and/or a classification not to be generated (as compared with a correct output and/or a correct classification being generated if the set of data i is not added to the plurality of sets of data) (e.g., the addition of the set of data i to the plurality of sets of data causes a loss of 100). Alternatively and/or additionally, if a=b, then an addition of the set of data i to the plurality of sets of data may cause an incorrect output and/or an incorrect classification to be generated (as compared with no output if the set of data i is not added to the plurality of sets of data) (e.g., the addition of the set of data i to the plurality of sets of data causes a loss of 500). In some examples, the Shapley value of the set of data i is

$$- \frac{100}{n} {{Σ}_{\{ ( a , b ) \vert a = b + 1 \}} ( \begin{matrix}n - 1 \\ a + b\end{matrix} )}^{- 1} ( \begin{matrix}\vert A \vert \\ a\end{matrix} ) ( \begin{matrix}\vert B \vert \\ b\end{matrix} ) - \frac{500}{n} {{Σ}_{\{ ( a , b ) \vert a = b \}} ( \begin{matrix}n - 1 \\ a + b\end{matrix} )}^{- 1} ( \begin{matrix}\vert A \vert \\ a\end{matrix} ) ( \begin{matrix}\vert B \vert \\ b\end{matrix} ) .$$

In some examples, Shapley values may be the same for sets of data that are associated with the same label. For example, a first exemplary set of Shapley values of the plurality of Shapley values may be associated with first exemplary sets of data, of the plurality of sets of data, that are associated with a first exemplary label. The first exemplary set of Shapley values may be the same (each Shapley value of the first exemplary set of Shapley values may be equal to other Shapley values of the first exemplary set of Shapley values due to the first exemplary sets of data being associated with and/or assigned the first exemplary label). Alternatively and/or additionally, a second exemplary set of Shapley values of the plurality of Shapley values may be associated with second exemplary sets of data, of the plurality of sets of data, that are associated with a second exemplary label. The second exemplary set of Shapley values may be the same (e.g., each Shapley value of the second exemplary set of Shapley values may be equal to other Shapley values of the second exemplary set of Shapley values due to the second exemplary sets of data being associated with and/or assigned the second exemplary label).

In some examples, the plurality of Shapley values, associated with the plurality of sets of data, generated based upon a first exemplary out-of-sample input associated with a first exemplary label, may be the same as a second exemplary plurality of Shapley values, associated with the plurality of sets of data, generated based upon a second exemplary out-of-sample input associated with the first exemplary label. Accordingly, computing Shapley values for the plurality of sets of data over a set of out-of-sample inputs may merely require four (and/or a different number of) Shapley value computations, one for each varying combination of a label associated with a set of data and a label associated with an out-of-sample input.

In some examples, rather than computing Shapley values for the plurality of sets of data over (all of) a set of out-of-sample inputs, Shapley values for the plurality of sets of data may be computed over a subset of the set of out-of-sample inputs. A Shapley value may be determined for each set of data of the plurality of sets of data based upon the Shapley values computed over the subset of the set of out-of-sample inputs. For example, a sum of the Shapley values computed over the set of out-of-sample inputs may be equal to a sum of Shapley values determined for the plurality of sets of data based upon the Shapley values computed over the subset of the set of out-of-sample inputs.

In some examples, the plurality of sets of data may be partitioned into multiple parts of the plurality of sets of data. In some examples, for each part of the plurality of sets of data, one or more Shapley values may be determined for one or more sets of data of the part of the plurality of sets of data, an average of the one or more Shapley values may be determined and/or the average of the one or more Shapley values may be assigned to sets of data of the part of the plurality of sets of data, wherein the one or more sets of data may not comprise all of the sets of data of the part of the plurality of sets of data.

A second example for determining Owen values for sources associated with two or more sets of data of the plurality of sources is provided. One or more of the techniques presented in the second example for determining Owen values may be implemented in embodiments using a frequency-based process and/or a different technique. In the second example for determining Owen values, each source of the plurality of sources may be associated with (and/or may provide) two or more sets of data of the plurality of sets of data. In some examples, m corresponds to a quantity of sources of the plurality of sources. In some examples, C₁, . . . , Cₘ corresponds to sets of indices of a plurality of groups of sets of data associated with the plurality of sources (e.g., each source of the plurality of sources may be associated with a group of sets of data of the plurality of groups of sets of data).

In some examples, an output (e.g., a classification and/or a decision) may be generated based upon the plurality of sets of data and/or an out-of-sample input x. In some examples, a label y may correspond to the out-of-sample input x. In some examples, the label y may not be known when the out-of-sample input x is provided and/or the output is generated based upon the out-of-sample input x and/or the plurality of sets of data. In some examples, Owen values are computed based upon the plurality of sets of data, a value of the output (and/or a value of an action performed based upon the output). In some examples, an Owen value associated with a set of data used for generating two or more outputs based upon two or more out-of-sample inputs may correspond to a sum of two or more Owen values associated with the set of data corresponding to generating the two or more outputs. In some examples, an Owen value of a source is determined by determining a sum of two or more Owen values associated with a group of sets of data associated with the source.

In some examples, Owen values correspond to nested expectations, over permutations of groups of sets of data and permutations of sets of data within each group of sets of data of the plurality of groups of sets of data. In some examples, dynamic programming may be used to determine permutations over groups of sets of data. Alternatively, one or more techniques associated with the first example for determining Shapley values for the plurality of sets of data may be used to determine permutations over sets of data within each group of sets of data of the plurality of groups of sets of data.

One or more techniques are provided for determining an Owen value for a set of data in a group of sets of data Cₘ corresponding to a last group of sets of data of the plurality of groups of sets of data. In some examples, for determining Owen values for other sets of data in other groups of sets of data, indices of the plurality of groups of sets of data may be reordered such that a group of sets of data of interest becomes the group of sets of data m.

In some examples, P_{j,s,a,b} corresponds to a probability that a random permutation of groups of sets of data places groups of sets of data s of groups of sets of data C₁, . . . , C₁ before the group of sets of data Cₘ and/or other groups after the group of sets of data Cₘ and/or that the groups of sets of data s comprise a sets of data of the plurality of sets of data associated with label y and/or b sets of data associated with a second label different than the label y. Accordingly, base case values may correspond to P_{0,0,0,0}=1 and/or ∀(s,a,b)≠(0,0,0): P_{0,s,a,b}=0.

In some examples, aⱼ corresponds to a quantity of sets of data indexed by Cⱼ that are associated with the label y and/or bⱼ corresponds to a quantity of sets of data indexed by Cⱼ that are not associated with the label y. In some examples,

$${P}_{j , s , a , b} = \frac{s + 1}{j + 1} {P}_{j - 1 , s - 1 , a - {a}_{j} , b - {b}_{j}} + \frac{j - s}{j + 1} {P}_{j - 1 , s , a , b}$$

is true. In some examples, P_{a,b}=Σₛ₌₀^{m-1}P_{m-1,s,a,b} is true. Accordingly, the Owen value for a set of data i in the group of sets of data Cₘ on the out-of-sample input x with the label y is

$${Σ}_{( a , b ) ∈ R} {Σ}_{( {a}^{′} , {b}^{′} ) \vert {a}^{′} \leq a , {b}^{′} \leq b} {P}_{a - {a}^{′} , b - {b}^{′}} \frac{1}{\vert {C}_{m} \vert} {( \begin{matrix}\vert {C}_{m} \vert - 1 \\ \vert {A}_{m} \vert + \vert {B}_{m} \vert\end{matrix} )}^{- 1} ( \begin{matrix}\vert {A}_{m} \vert \\ {a}^{′}\end{matrix} ) ( \begin{matrix}\vert {B}_{m} \vert \\ {b}^{′}\end{matrix} ) {Δ}_{i} ( a , b ) ,$$

where Aₘ corresponds to sets of data of the group of sets of data Cₘ that are associated with the label y (without the set of data i), and/or Bₘ corresponds to sets of data of the group of sets of data Cₘ that are not associated with the label y.

In some examples, Owen values may be the same for sets of data, of a group of sets of data, that are associated with the same label. In some examples, the plurality of Owen values, associated with the plurality of sources, generated based upon a first exemplary out-of-sample input associated with a first exemplary label, may be the same as a second exemplary plurality of Owen values, associated with the plurality of sources, generated based upon a second exemplary out-of-sample input associated with the first exemplary label. Accordingly, computing Owen values for the plurality of sources over a set of out-of-sample inputs may merely require computations for each varying combination of a group of sets of data, a label associated with a set of data and/or a label associated with an out-of-sample input. In some examples, rather than computing Owen values for the plurality of sources over (all of) a set of out-of-sample inputs, Owen values for the plurality of sources may be computed over a subset of the set of out-of-sample inputs. An Owen value may be determined for each source of the plurality of sources based upon the Owen values computed over the subset of the set of out-of-sample inputs. For example, a sum of the Owen values computed over the set of out-of-sample inputs may be equal to a sum of Owen values determined for the plurality of sources based upon the Owen values computed over the subset of the set of out-of-sample inputs.

In some examples, k nearest neighbors may be identified to classify an out-of-sample input x. In some examples, the k nearest neighbors may be identified using a k nearest neighbor classifier and/or one or more k nearest neighbor techniques. In some examples, the k nearest neighbors may correspond to sets of data of the plurality of sets of data that have inputs that are closest to the out-of-sample input x according to a metric. In some examples, an output is generated based upon the k nearest neighbors. In some examples, the output corresponds to a classification of the out-of-sample input x. In some examples, the output is determined based upon a label associated with a threshold quantity of the k nearest neighbors (e.g., the label may be associated with a majority of the k nearest neighbors). In some examples, the output is indicative of the label associated with the threshold quantity of the k nearest neighbors.

In some examples, k may be odd (and/or even) and/or the plurality of sets of data may be associated with binary classification (e.g., there are merely two labels assigned to sets of data of the plurality of sets of data) (and/or a different type of classification associated with more than two labels). Accordingly, if k is odd and/or the plurality of sets of data are associated with the binary classification, a tie may not occur (e.g., a tie corresponds to a first exemplary quantity of sets of data of the k nearest neighbors associated with a first label being equal to a second exemplary quantity of sets of data of the k nearest neighbors associated with a second label). In some examples, the metric corresponds to a function that takes two example inputs and/or returns a number.

A third example for determining Shapley values for the plurality of sets of data is provided. One or more of the techniques presented in the third example for determining Shapley values may be implemented in embodiments using one or more k nearest neighbor techniques and/or a different technique. An out-of-sample input x may be provided. A label y may correspond to the out-of-sample input x. In some examples, the label y may not be known when the out-of-sample input x is provided and/or an output is generated based upon the out-of-sample input x and/or the plurality of sets of data. In some examples, the output may be generated based upon the plurality of sets of data and/or the out-of-sample input x. In some examples, n corresponds to a quantity of sets of data of the plurality of sets of data.

In some examples, 1, . . . , n corresponds to an index of sets of data of the plurality of sets of data. In a first case, if S has k−1 sets of data, an addition of a set of data i to the plurality of sets of data indexed by S may cause generation of the output based upon k sets of data to be possible. In a second case, an addition of a set of data i to the plurality of sets of data indexed by S may displace a set of data of k sets of data (e.g., k nearest neighbors of the out-of-sample input x), which may cause the output to be different as compared with the set of data i not being added to the plurality of sets of data.

In the first case, an output may not be generated (and/or a generated output may not be indicative of a label and/or a classification) if there are fewer than k sets of data in the plurality of sets of data. In some examples, vₙ corresponds to a value of performing an action (and/or not performing an action) based upon an output not being generated (and/or based upon the output being generated without a label and/or a classification). In some examples, v_{c} corresponds to a value of performing an action (and/or not performing an action) based upon the output if the output is correct (e.g., the output and/or the classification may be correct if the output and/or the classification is indicative of the label y). In some examples, v_{w} corresponds to a value of performing an action (and/or not performing an action) based upon the output if the output is incorrect (e.g., the output and/or the classification may be incorrect if the output and/or the classification is indicative of a label different than the label y). In some examples, if |S|=k−1, then v(S)=vₙ. In some examples, sets of data indexed by S∪{i} comprises first exemplary sets of data associated with the label y. In some examples, if a quantity of sets of data of the first exemplary sets of data meets a threshold quantity (and/or if the first exemplary sets of data associated with the label y correspond to a majority of the sets of data indexed by S∪{i}), v(S∪{i}=v_{c}, otherwise v(S∪{i}=u_{w}.

In some examples, yᵢ corresponds to a label of the set of data i, an indicator function I( ) corresponds to 1 if an argument of the indicator function I( ) is true and/or 0 if the argument is not true, and/or A corresponds to an index of sets of data of the plurality of sets of data associated with the label y. In some examples, a contribution to a Shapley value for the set of data i for generating an output (e.g., a classification) based upon the out-of-sample input x with the label y is

$${f}_{i} ( x , y ) = \frac{1}{n} {( \begin{matrix}n - 1 \\ k - 1\end{matrix} )}^{- 1} [ {\sum }_{a = 0}^{\frac{k - 1}{2} - I ( {y}_{i} = y )} ( \begin{matrix}\vert A \vert \\ a\end{matrix} ) ( \begin{matrix}n - 1 - \vert A \vert \\ k - 1 - a\end{matrix} ) {υ}_{w} + {\sum }_{a = \frac{k - 1}{2} - I ( {y}_{i} = y ) + 1}^{k - 1} ( \begin{matrix}\vert A \vert \\ a\end{matrix} ) ( \begin{matrix}n - 1 - \vert A \vert \\ k - 1 - a\end{matrix} ) {υ}_{c} ] - \frac{{υ}_{n}}{n} .$$

In the second case, a set of data j may correspond to a kth nearest neighbor to the out-of-sample input x in S. In some examples, if the set of data j is closer to the out-of-sample input x than the set of data j, then the set of data i replaces the example j in the k sets of data (e.g., k nearest neighbors of the out-of-sample input x), which may cause the output to be different as compared with the set of data i not being added to the plurality of sets of data. In some examples, adding the set of data i to the plurality of sets of data may cause the output to be different as compared with the set of data i not being added to the plurality of sets of data if the following conditions are met: the first set of data i is closer to the out-of-sample input x than the set of data j; a label associated with the first set of data i is different than a label associated with the set of data j; and/or half of k−1 of the k sets of data are associated with the label y. In some examples, if the conditions are met and/or if the set of data i is associated with the label y, then v(S∪{i})−v(S)=v_{c}−v_{w} (because adding the set of data i causes the output to become correct). In some examples, if the conditions are met and/or if the set of data i is associated with the second label different than the label y, then v(S∪{i})−v(S)=v_{w}−v_{c}.

In some examples, J corresponds to an index of sets of data that are associated with a label different than a label of the set of data i and/or that have greater distances to the out-of-sample input x than the set of data i. In some examples, if the set of data i has the label y, then Δᵢv=v_{c}−v_{w}, otherwise Δᵢv=v_{w}−v_{c}. In some examples, Aⱼ corresponds to an index of sets of data, excluding the set of data i, that are associated with the label y and/or that have lower distances to the out-of-sample input x than the set of data j. In some examples, Bⱼ corresponds to an index of sets of data, excluding the set of data i, that are associated with the second label different than the label y. In some examples, the Shapley value for the set of data i changing the output and/or the classification associated with the out-of-sample input x with the label y is

$${g}_{i} ( x , y ) = {Σ}_{j ∈ J} \frac{1}{\vert {A}_{j} \vert + \vert {B}_{j} \vert + 2} {( \begin{matrix}\vert {A}_{j} \vert + \vert {B}_{j} \vert + 1 \\ k\end{matrix} )}^{- 1} ( \begin{matrix}\vert {A}_{j} \vert \\ \frac{k - 1}{2}\end{matrix} ) ( \begin{matrix}\vert {B}_{j} \vert \\ \frac{k - 1}{2}\end{matrix} ) {Δ}_{i} υ .$$

In some examples, the Shapley value for the set of data i corresponds to fᵢ(x,y)+gᵢ(x,y). In some examples, fᵢ(x,y) may be computed by determining a quantity of sets of data associated with the label y.

In some examples, the plurality of sets of data may be ordered and/or numbered based upon distances to the out-of-sample input x (e.g., a set of data 1 is closest to the out-of-sample input x, the set of data 2 is second closest to the out-of-sample input x, etc.). In some examples, aⱼ corresponds to a quantity of sets of data that are closer to the out-of-sample input x than the set of data j and/or that are associated with the label y. In some examples, |Aⱼ|=aⱼ−I (yᵢ=y) (due to aⱼ excluding the set of data i). In some examples, bⱼ corresponds to a quantity of sets of data that are closer to the out-of-sample input x than the set of data j and/or that are associated with the second different than the label y. In some examples, |Bⱼ|=bⱼ−I(yᵢ≠y). In some examples, where (yᵢ=y) and/or (yᵢ≠ y), |Aⱼ|+|Bⱼ|=aⱼ+bⱼ−1. In some examples, for each out-of-sample input, aⱼ and/or bⱼ may be computed using a recurrence: a₁=b₁=0, aⱼ=aⱼ₋₁+I(yⱼ₋₁=y) and/or bⱼ=bⱼ₋₁+I(yᵢ₋₁≠y). In some examples, gᵢ(x,y) is equal to

$${s}_{i} ≡ {Σ}_{j = i + 1}^{n} I ( {y}_{j} \neq {y}_{i} ) \frac{1}{{a}_{j} + {b}_{j} + 1} {( \begin{matrix}{a}_{j} + {b}_{j} \\ k\end{matrix} )}^{- 1} ( \begin{matrix}{a}_{j} - I ( {y}_{i} = y ) \\ \frac{k - 1}{2}\end{matrix} ) ( \begin{matrix}{b}_{j} - I ( {y}_{i} \neq y ) \\ \frac{k - 1}{2}\end{matrix} ) {Δ}_{i} υ .$$

In some examples, for each label value u:

$${s}_{i , u} ≡ {Σ}_{j = i + 1}^{n} I ( {y}_{j} \neq u ) \frac{1}{{a}_{j} + {b}_{j} + 1} {( \begin{matrix}{a}_{j} + {b}_{j} \\ k\end{matrix} )}^{- 1} ( \begin{matrix}{a}_{j} - I ( u = y ) \\ \frac{k - 1}{2}\end{matrix} ) ( \begin{matrix}{b}_{j} - I ( u \neq y ) \\ \frac{k - 1}{2}\end{matrix} ) {Δ}_{i} υ .$$

In some examples, sᵢ=s_{i,y}_{ᵢ}. In some examples, s_{i,u} is computed, for each value of u, using a recurrence: s_{n,u}=0 and/or

$${s}_{i , u} = {s}_{i + 1 , u} + I ( {y}_{j} \neq u ) \times \frac{1}{{a}_{i + 1} + {b}_{i + 1} + 1} {( \begin{matrix}{a}_{i + 1} + {b}_{i + 1} \\ k\end{matrix} )}^{- 1} ( \begin{matrix}{a}_{i + 1} - I ( u = y ) \\ \frac{k - 1}{2}\end{matrix} ) ( \begin{matrix}{b}_{i + 1} - I ( u \neq y ) \\ \frac{k - 1}{2}\end{matrix} ) {Δ}_{i} υ .$$

In some examples, rather than determining (an exact value) of s_{i,u}, an estimation of s_{i,u} may be determined. For example, s_{i,u} may be determined for values of u that are less than a limit t, and/or values of s_{i,u} for values of u that are greater than the limit t may be defined as 0. In some examples, the Shapley value for the set of data i is determined using fᵢ(x,y)+gᵢ(x,y), wherein gᵢ(x,y) is equal to

$${s}_{i} ≡ {Σ}_{j = i + 1}^{n} I ( {y}_{j} \neq {y}_{i} ) \frac{1}{{a}_{j} + {b}_{j} + 1} {( \begin{matrix}{a}_{j} + {b}_{j} \\ k\end{matrix} )}^{- 1} ( \begin{matrix}{a}_{j} - I ( {y}_{i} = y ) \\ \frac{k - 1}{2}\end{matrix} ) ( \begin{matrix}{b}_{j} - I ( {y}_{i} \neq y ) \\ \frac{k - 1}{2}\end{matrix} ) {Δ}_{i} υ .$$

A fourth example for determining Owen values for the plurality of sets of data is provided. One or more of the techniques presented in the fourth example for determining Owen values may be implemented in embodiments using one or more k nearest neighbor techniques and/or a different technique. In the fourth example, each source of the plurality of sources may be associated with (and/or may provide) two or more sets of data of the plurality of sets of data. In some examples, m corresponds to a quantity of sources of the plurality of sources. In some examples, C₁, . . . , Cₘ corresponds to sets of indices of a plurality of groups of sets of data associated with the plurality of sources (e.g., each source of the plurality of sources may be associated with a group of sets of data of the plurality of groups of sets of data).

An out-of-sample input x may be provided. A label y may correspond to the out-of-sample input x. In some examples, the label y may not be known when the out-of-sample input x is provided and/or an output is generated based upon the out-of-sample input x and/or the plurality of sets of data. In some examples, the output may be generated based upon the plurality of sets of data and/or the out-of-sample input x.

In some examples, an Owen value of a set of data i in a group of sets of data m for a value of an action performed based upon the output (e.g., the classification) generated based upon k sets of data (e.g., k nearest neighbors of the out-of-sample input x). In some examples, an Owen value of a source is determined by determining a sum of two or more Owen values associated with a group of sets of data associated with the source.

In some examples, for each set of data j indexed by J, q_{h,s,a,b} may correspond to a probability over permutations of groups of sets of data that s of the groups of sets of data among C₁, . . . , Cₕ precede the group of sets of data Cₘ and/or the groups of sets of data comprise a sets of data indexed by Aⱼ, b examples indexed by Bⱼ and/or the set of data j if j∉Cₘ. In some examples, if j∉Cₘ, j∈C₁. In some examples, if j∉Cₘ, the base cases may correspond to q_{0,0,0,0}=1 and/or ∀(s,a,b)≠(0,0,0): q_{0,s,a,b}=0.

In some examples, aₕ=|Aⱼ∩Cₕ| and/or bₕ=|Bⱼ∩Cₕ|. In some examples, if j∉Cₘ, then base cases may correspond to q_{1,1,a}_{₁}_{,b}_{₁}=½ and/or ∀(s,a,b)≠(1,a₁,b₁):q_{1,s,a,b}=0.

In some examples, for a recurrence:

$${q}_{h , s , a , b} = \frac{s + 1}{h + 1} {q}_{h - 1 , s - 1 , a - {a}_{h} , b - {b}_{h}} + \frac{h - s}{h + 1} {q}_{h - 1 , s , a , b} .$$

In some examples q_{a,b}=Σₛ₌₀^{m-1}q_{m-1,s,a,b}. In some examples, Jₘ=J∩Cₘ. In some examples, a portion of the Owen value for the set of data i changing a k-nearest neighbor output and/or classification for out-of-sample input x with the label y (given that the set of data i is associated with the group of sets of data Cₘ) is

$${\hat{g}}_{m , i} ( x , y ) = {\sum }_{j ∈ J - {J}_{m}} {\sum }_{( a , b ) \vert a \leq {a}_{m} , b \leq {b}_{m}} {q}_{\frac{k - 1}{2} - a , \frac{k - 1}{2} - b} \frac{1}{{a}_{m} + {b}_{m} + 1} {( \begin{matrix}{a}_{m} + {b}_{m} \\ a + b\end{matrix} )}^{- 1} ( \begin{matrix}{a}_{m} \\ a\end{matrix} ) ( \begin{matrix}{b}_{m} \\ b\end{matrix} ) {Δ}_{i} υ + {\sum }_{j ∈ {J}_{m}} {\sum }_{( a , b ) \vert a \leq {a}_{m} , b \leq {b}_{m}} {q}_{\frac{k - 1}{2} - a , \frac{k - 1}{2} - b} \frac{1}{{a}_{m} + {b}_{m} + 2} {( \begin{matrix}{a}_{m} + {b}_{m} + 1 \\ a + b + 1\end{matrix} )}^{- 1} ( \begin{matrix}{a}_{m} \\ a\end{matrix} ) ( \begin{matrix}{b}_{m} \\ b\end{matrix} ) {Δ}_{i} υ .$$

In some examples, a portion of the Owen value for the set of data i associated with being a kth example in the plurality of sets of data (causing the output and/or the classification to be generated if the set of data i is added to the plurality of sets of data) may correspond to fᵢ(x,y). In some examples, A may correspond to an index of sets of data of the plurality of sets of data, associated with the label y, excluding the set of data i. In some examples, B may correspond to an index of sets of data of the plurality of sets of data, associated with the second label different than the label y. In some examples, aₕ=|A∩Cₕ| and/or bₕ=|B∩Cₕ|. In some examples, and/or q_{a,b} may be determined based upon

$${q}_{h , s , a , b} = \frac{s + 1}{h + 1} {q}_{h - 1 , s - 1 , a - {a}_{h} , b - {b}_{h}} + \frac{h - s}{h + 1} {q}_{h - 1 , s , a , b}$$

and/or q_{a,b}=Σₛ₌₀^{m-1}q_{m-1,s,a,b}. In some examples, q_{a,b} corresponds to a probability over permutations over groups of sets of data that groups of sets of data preceding the group of sets of data Cₘ together have a sets of data associated with the label y and/or b sets of data associated with the second label different than the label y. In some examples, using aₕ, bₕ and/or q_{a,b}, a portion of the Owen value for the set of data i associated with being a kth example in the plurality of sets of data may correspond to

$${\hat{f}}_{m , i} ( x , y ) = {\sum }_{( a , b , {a}^{′} , {b}^{′} ) \vert a + b + {a}^{′} + {b}^{′} = k - 1 and a + {a}^{′} + I ( {y}_{i} = y ) < \frac{k}{2}} {q}_{a , b} \frac{1}{\vert {C}_{m} \vert} {( \begin{matrix}\vert {C}_{m} \vert - 1 \\ {a}^{′} + {b}^{′}\end{matrix} )}^{- 1} ( \begin{matrix}{a}_{m} \\ {a}^{′}\end{matrix} ) ( \begin{matrix}{b}_{m} \\ {b}^{′}\end{matrix} ) ( {υ}_{w} - {υ}_{n} ) + {\sum }_{( a , b , {a}^{′} , {b}^{′} ) \vert a + b + {a}^{′} + {b}^{′} = k - 1 and a + {a}^{′} + I ( {y}_{i} = y ) > \frac{k}{2} } {q}_{a , b} \frac{1}{\vert {C}_{m} \vert} {( \begin{matrix}\vert {C}_{m} \vert - 1 \\ {a}^{′} + {b}^{′}\end{matrix} )}^{- 1} ( \begin{matrix}{a}_{m} \\ {a}^{′}\end{matrix} ) ( \begin{matrix}{b}_{m} \\ {b}^{′}\end{matrix} ) ( {υ}_{c} - {υ}_{n} ) .$$

In some examples, the Owen value for the set of data i in the group of sets of data Cₘ may correspond to \hat{f}_{m,i}(x,y)+ĝ_{m,i}(x,y).

At 410, a plurality of payment values associated with the plurality of sources may be generated based upon the plurality of values. A first payment value of the plurality of payment values may be associated with a first source of the plurality of sources. Alternatively and/or additionally, a second payment value of the plurality of payment values may be associated with a second source of the plurality of sources.

In some examples, the plurality of payment values may be equal to the plurality of values. Alternatively and/or additionally, the plurality of payment values may be different than the plurality of values. For example, one or more operations (e.g., mathematical operations) may be performed using the plurality of values and/or the first value to determine the plurality of payment values. In some examples, the plurality of values may be indicative of a plurality of proportions (and/or percentages) of the first value associated with each source of the plurality of sources. For example, the first payment value of the plurality of payment values may be determined by performing one or more operations (e.g., mathematical operations) using a first proportion (and/or a first percentage) associated with the first source and/or the first value. In some examples, the first payment value may correspond to an amount of a currency.

At 412, a first payment associated with the first payment value may be transferred to a first account associated with the first source. At 414, a second payment associated with the second payment value may be transferred to a second account associated with the second source.

FIG. 5D illustrates a payment 536 being transferred to a first exemplary account 538 (e.g., a bank account) associated with the first user and/or the client device 500. In some examples, an exemplary payment value is determined based upon an exemplary value of the plurality of values associated with the client device 500 and/or the first user. In some examples, the payment 536 is associated with the exemplary payment value. In some examples, the payment 536 is transferred from a second exemplary account 534 (e.g., a bank account) associated with the first system to the first exemplary account 538 associated with the first user and/or the client device 500.

In some examples, the first payment may be (automatically) transferred to a banking account associated with the first source. Alternatively and/or additionally, the first payment may be (automatically) transferred to a debit account and/or a credit account associated with first source. Alternatively and/or additionally, the first payment may correspond to a cryptocurrency payment. For example, the first payment may be transferred to an address associated with a cryptocurrency account and/or a cryptocurrency wallet associated with the first source.

In some examples, a payment document (such as a check) may be automatically printed and/or issued based upon the first payment value. In some examples, the payment document may be printed based upon stored identification information associated with the first source (e.g., the stored identification information may comprise one or more of a name of an individual and/or a business associated with the first source, an account number associated with the first source, etc.). In some examples, the payment document may be sent (e.g., shipped) to a mailing address associated with the first source (e.g., the mailing address may be determined based upon the stored identification information).

In some examples, an amount of the first payment may correspond to the first payment value (e.g., if the first payment value is indicative of $100, the first payment may correspond to a payment of $100 to the first account associated with the first source). In some examples, the first payment may be associated with a plurality of payment values. For example, the plurality of payment values, comprising the first payment value, may be combined to generate a third payment value (e.g., the third payment value may correspond to a sum and/or a different combination of the plurality of payment values). For example, the first payment may correspond to the third payment value (e.g., if the third payment value is indicative of $500, the first payment may correspond to a payment of $500 to the first account associated with the first source).

In some examples, payments may be transferred to the first account associated with the first source periodically (e.g., once per month, once per week, etc.). For example, payment values associated with the first source may be generated based upon actions being performed based upon one or more sets of data associated with the first source. In some examples, the payment values may be recorded and/or stored in a period of time. A total payment value may be generated based upon the payment values recorded and/or stored in the period of time. In some examples, a third payment associated with the total payment value may be transferred to the first account associated with the first source (e.g., the third payment may be transferred to the first account after and/or upon completion of the period of time).

Alternatively and/or additionally, a payment may be transferred to the first account responsive to a second total payment value of one or more payment values associated with the first source meeting a threshold payment value. In some examples, the one or more payment values may be unpaid. The one or more payment values may be generated based upon one or more actions being performed based upon one or more sets of data associated with the first source. In some examples, responsive to a payment value of the one or more payment values being generated, the second total payment value may be updated. In some examples, the second total payment value may be (periodically) monitored to determine whether the second total payment value meets the threshold payment value. In some examples, responsive to the second total payment value meeting the threshold payment value, a fourth payment associated with the second total payment value may be transferred to the first account associated with the first source. In some examples, the threshold payment value may be determined based upon historical payment information associated with the first source. For example, the historical payment information may be indicative of a rate at which payments are transferred for the first source (e.g., payments may be transferred for the first source upon the threshold payment value being met). In some examples, the threshold payment value may be modified responsive to the rate at which payments are transferred for the first source meeting a threshold payment rate.

It may be appreciated that the disclosed subject matter may assist a user (and/or a client device associated with the user) in authorizing a system to use one or more sets of data associated with the user for performance of actions based upon the one or more sets of data. Alternatively and/or additionally, the disclosed subject matter may assist the user in receiving compensation based upon a value of the one or more sets of data and/or a value of actions performed based upon the one or more sets of data.

Implementation of at least some of the disclosed subject matter may lead to benefits including, but not limited to, a more accurate determination of a value associated with a source (e.g., as a result of determining a first value of an action performed based upon one or more sets of data associated with the source, as a result of determining a Shapley value associated with the source based upon the first value of the action if the action is performed based upon a single set of data associated with the source, as a result of determining an Owen value associated with the source based upon the first value of the action if the action is performed based upon two or more sets of data associated with the source, etc.).

Alternatively and/or additionally, implementation of at least some of the disclosed subject matter may lead to benefits including faster determination of Shapley values and/or Owen values. Using one or more of the techniques provided herein, Shapley values and/or Owen values may be computed for sources and/or sets of data in seconds (and/or microseconds). This can be compared with some existing techniques for determination of Shapley values and/or Owen values, that if used for determining Shapley values and/or Owen values for a plurality of sources associated with a plurality of sets of data, can take years (and/or centuries) to compute the Shapley values and/or the Owen values, making those techniques infeasible for many functions.

In some examples, at least some of the disclosed subject matter may be implemented on a client device, and in some examples, at least some of the disclosed subject matter may be implemented on a server (e.g., hosting a service accessible via a network, such as the Internet).

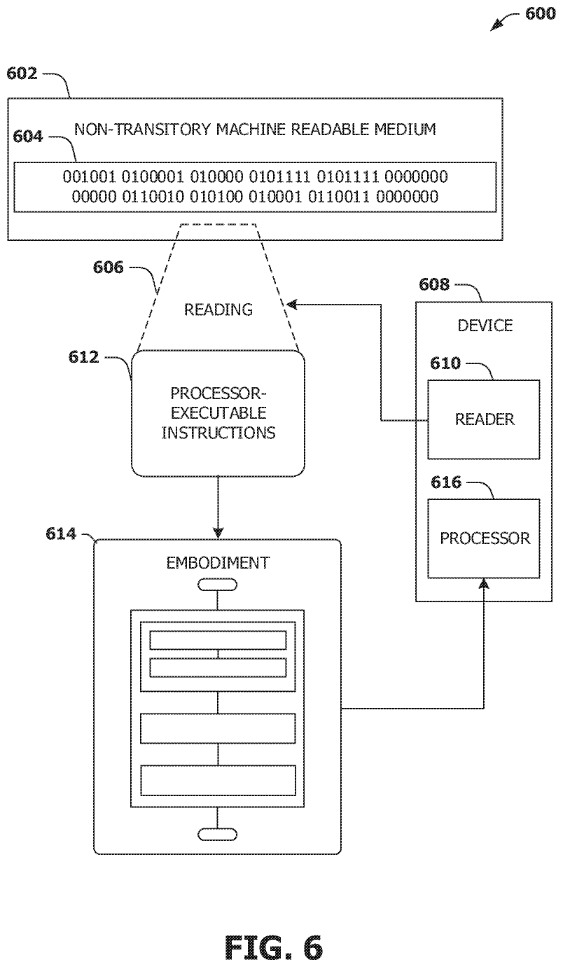

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4, for example. In some embodiments, the processor-executable instructions 612 are configured to cause implementation of a system, such as at least some of the exemplary system 501 of FIGS. 5A-5D, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
performing one or more actions based upon a plurality of sets of data;
determining a first value associated with performance of the one or more actions;
determining, based upon the plurality of sets of data, a plurality of sources of the plurality of sets of data, wherein a source of the plurality of sources is associated with one or more sets of data of the plurality of sets of data;
determining, based upon the plurality of sets of data and the first value, a plurality of values associated with the plurality of sources, wherein a value of the plurality of values is associated with a source of the plurality of sources;
generating, based upon the plurality of values, a plurality of payment values associated with the plurality of sources, wherein:
a first payment value of the plurality of payment values is associated with a first source of the plurality of sources; and
a second payment value of the plurality of payment values is associated with a second source of the plurality of sources;
transferring a first payment associated with the first payment value to a first account associated with the first source; and
transferring a second payment associated with the second payment value to a second account associated with the second source.

2. The method of claim 1, comprising:
prior to the performing the one or more actions, controlling a graphical user interface of a client device associated with the first source of the plurality of sources to display a request for access to one or more sets of data of the first source, wherein the request comprises a selectable input associated with providing access to the one or more sets of data of the first source; and
responsive to receiving a selection of the selectable input, generating the plurality of sets of data with the one or more sets of data of the first source.

3. The method of claim 1, comprising:
controlling a graphical user interface of a client device associated with a third source to display a selectable input associated with not providing access to one or more sets of data of the third source; and
responsive to receiving a selection of the selectable input, generating the plurality of sets of data without the one or more sets of data of the third source.

4. The method of claim 1, comprising:
identifying a second plurality of sets of data;
evaluating the second plurality of sets of data to determine whether analysis of each set of data of the second plurality of sets of data is authorized; and
responsive to determining that analysis of a first set of data of the second plurality of sets of data is authorized and that analysis of a second set of data of the second plurality of sets of data is not authorized, generating the plurality of sets of data with the first set of data and without the second set of data.

5. The method of claim 1, wherein the determining the plurality of values comprises:
determining that the first source is associated with two or more sets of data comprising a first set of data of the plurality of sets of data and a second set of data of the plurality of sets of data; and
responsive to determining that the first source is associated with the two or more sets of data, determining an Owen value, of the plurality of values, associated with the first source.

6. The method of claim 1, wherein the determining the plurality of values comprises:
determining that the first source is associated with a single set of data of the plurality of sets of data; and
responsive to determining that the first source is associated with the single set of data, determining a Shapley value, of the plurality of values, associated with the first source.

7. The method of claim 1, wherein the determining the plurality of values comprises determining a plurality of Owen values.

8. The method of claim 1, wherein the determining the plurality of values comprises determining a plurality of Shapley values.

9. The method of claim 1, wherein the determining the first value is based upon an amount of revenue associated with the performance of the one or more actions.

10. The method of claim 1, wherein a set of data of the plurality of sets of data is associated with at least one of:
user activity performed via a client device;
one or more searches performed via the client device;
one or more emails received via an email account; or
one or more messages received via the client device.

11. The method of claim 1, wherein the performing the one or more actions comprises:
selecting, based upon the plurality of sets of data, a content item for presentation via a client device; and
transmitting the content item to the client device.

12. The method of claim 1, wherein the performing the one or more actions comprises at least one of:
buying one or more first shares in an equity market; or
selling one or more second shares in the equity market.

13. The method of claim 1, wherein the performing the one or more actions comprises performing a clinical trial based upon the plurality of sets of data.

14. The method of claim 1, wherein the performing the one or more actions comprises setting an insurance rate based upon the plurality of sets of data.

15. A computing device comprising:
a processor; and
memory comprising processor-executable instructions that when executed by the processor cause performance of operations, the operations comprising:
detecting performance of one or more actions;
determining a plurality of sets of data used for the performance of the one or more actions;
determining a first value associated with the performance of the one or more actions;
determining, based upon the plurality of sets of data, a plurality of sources of the plurality of sets of data, wherein a source of the plurality of sources is associated with one or more sets of data of the plurality of sets of data;
determining, based upon the plurality of sets of data and the first value, a plurality of values associated with the plurality of sources;
determining, based upon the plurality of values, a plurality of payment values associated with the plurality of sources, wherein:
a first payment value of the plurality of payment values is associated with a first source of the plurality of sources; and
a second payment value of the plurality of payment values is associated with a second source of the plurality of sources;
transferring a first payment associated with the first payment value to a first account associated with the first source; and
transferring a second payment associated with the second payment value to a second account associated with the second source.

16. The computing device of claim 15, the operations comprising:
prior to the detecting the performance of the one or more actions, controlling a graphical user interface of a client device associated with the first source of the plurality of sources to display a request for access to one or more sets of data of the first source, wherein the request comprises a selectable input associated with providing access to the one or more sets of data of the first source; and
responsive to receiving a selection of the selectable input, generating the plurality of sets of data with the one or more sets of data of the first source.

17. The computing device of claim 15, the operations comprising:
controlling a graphical user interface of a client device associated with a third source to display a selectable input associated with not providing access to one or more sets of data of the third source; and
responsive to receiving a selection of the selectable input, generating the plurality of sets of data without the one or more sets of data of the third source.

18. A non-transitory machine readable medium having stored thereon processor-executable instructions that when executed cause performance of operations, the operations comprising:
detecting performance of one or more actions;
determining a plurality of sets of data used for the performance of the one or more actions;
determining a first value associated with the performance of the one or more actions;
determining, based upon the plurality of sets of data, a plurality of sources of the plurality of sets of data, wherein a source of the plurality of sources is associated with one or more sets of data of the plurality of sets of data; and
determining, based upon the plurality of sets of data and the first value, a plurality of values associated with the plurality of sources.

19. The non-transitory machine readable medium of claim 18, the operations comprising:
determining, based upon the plurality of values, a plurality of payment values associated with the plurality of sources, wherein:
a first payment value of the plurality of payment values is associated with a first source of the plurality of sources; and
a second payment value of the plurality of payment values is associated with a second source of the plurality of sources.

20. The non-transitory machine readable medium of claim 19, the operations comprising:
transferring a first payment associated with the first payment value to a first account associated with the first source; and
transferring a second payment associated with the second payment value to a second account associated with the second source.
